(19) United States
(12) Patent Application Publication
(10) Pub. No.: US 2016/0057592 A1
(43) Pub. Date: Feb. 25, 2016

(54) International Converged Mobile Services

(71) Applicant: Truphone Limited, London (GB)

(72) Inventors: James Tagg, Kent (GB); Igor Borisoglebski, Alcabdeche (PT)

(21) Appl. No.: 14/784,948

(22) PCT Filed: Apr. 16, 2014
(86) PCT No.: PCT/GB2014/051204

§ 371 Date: Oct. 15, 2015

(30) Foreign Application Priority Data
Apr. 16, 2013 (GB) 1306891.1

(51) Int. Cl. H04W 4/16; H04L 29/12; H04W 8/28; H04M 3/42; H04W 24/04; H04W 64/00

(52) U.S. Cl. CPC H04W 4/16; H04W 24/04; H04W 64/006; H04W 8/28; H04M 3/42297; H04L 61/1588

(57) ABSTRACT

A method of managing a mobile network provides cellular telecommunications services to a subscriber in a plurality of countries. The method comprises providing a first set of said cellular telecommunications services from a central node covering all of the plurality of countries and providing a second set of said cellular telecommunications services from a plurality of regional nodes, each regional node providing the second set of cellular communications services to a subset of the plurality of countries.

### FIELD OF THE INVENTION

The invention relates to telecommunications, and specifically to the provision of a mobile phone network architecture and associated network elements and services.

### BACKGROUND TO THE INVENTION

Traditional mobile phone networks are built country-by-country. Each country therefore has a full set of equipment for all services located within that country. Thus not only are the radio towers and microwave backhauls—elements that must be located in the physical area they serve—located in the service country, but also all the signalling and ancillary customer care and billing equipment are located in each country. This approach lacks efficiency in a global network, and can be disadvantageous to operators and consumers. Some benefits can be provided by approaches that allow a consumer preferential access to a number of national networks. Such a system is disclosed in the applicant's earlier WO 2011/036484. This discloses a system in which a central service—an “IMSI Broker”—is adapted to provision the SIM of a mobile handset with new identities as required.

It would be desirable to reduce costs further by further addressing geographical limitations of this kind. This is challenging, because traditional mobile phone networks are built in this way. Networks performing other business models do not have such geographical limitations. For example, Internet companies such as Amazon or Google are able to locate infrastructure that serves the world in a few large data centres. Such centralization of infrastructure is not practical for a mobile phone network. It would not be desirable for calls from, for example, an Australian customer to an Australian customer to transit via a major data centre in a different geography entirely. This would increase latency on a call to unacceptable levels.

### SUMMARY OF INVENTION

The present inventors have appreciated that it is possible to allocate resources in a split between local, regional and central data centres to optimize the cost and quality of the network without causing unacceptable latency in individual geographies.

It is the object of this invention to provide a new form of mobile architecture that splits the network elements, operational support systems (OSS) and business support systems (BSS) amongst local, regional and central data centres. In one broad aspect, such a system has business support systems and operational support systems which are at least partially comprised in regional or central data centres, whereas network elements comprise local or regional data centres. Local data centres support a single country, regional data centres support multiple countries, whereas a central data centre supports the worldwide network. In a further aspect, a system for providing worldwide mobile services may comprise a central server adapted to perform OSS and BSS functions, and one or more regional servers and/or more one or more local (national) servers adapted to provide audio and data services.

In a first aspect, the invention provides a method of managing a mobile network to provide cellular telecommunications services to a subscriber in a plurality of countries, the method comprising: providing a first set of said cellular telecommunications services from a central node covering all of the plurality of countries; and providing a second set of said cellular telecommunications services from a plurality of regional nodes, each regional node providing the second set of cellular communications services to a subset of the plurality of countries.

This approach makes it possible to optimize the cost and quality of the network. Using this architecture makes it possible to for fewer components to be used to provide the overall network. Moreover, because fewer components are required each can be larger, of better quality and increased redundancy. Because components may serve the world or groups of countries rather than a single country, load balancing of the network can follow the sun. For example, the signalling servers might be unused by London customers when Tokyo customers are using the resource extensively.

Latency problems can be avoided as the network actions necessary to support an actual communication between two parties—in particular to support a voice call between two parties—may be carried out by a local data centre supporting both parties, or by relevant local data centres for each party. Actions related to the call that do not affect latency (such as other operational or business support functions handled by the OSS or BSS) may be handled by a regional data centre or a central data centre.

In a further broad aspect, the network may be arranged for redundancy such that a data centre associated with one geography may support another geography in the case of failure.

In some arrangements, networks are provided by local operators, with interaction with local networks and BSS and OSS functions provided at the data centres. The data centres may be connected by a dedicated communications backbone.

### BRIEF DESCRIPTION OF DRAWINGS

Specific embodiments of the invention will be described below, by way of example, with reference to the accompanying drawings, of which:

FIG. 1 shows an exemplary arrangement of a mobile phone network which extends across a number of countries;

FIG. 2 shows a logical distribution of network assets adapted to support a worldwide mobile network according to an embodiment of the invention;

FIG. 3 shows an example of the functions provide in a regional data centre according to an embodiment of the invention;

FIG. 4 shows the connectivity between network elements according to embodiment of the invention;

FIG. 5 shows an embodiment of the invention showing physical connections;

FIG. 6 shows an embodiment of the invention showing SS7 architecture;

FIG. 7 shows an embodiment of the invention showing a signalling approach for ISUP signalling;

FIG. 8 shows an embodiment of the invention showing a signalling approach for SCCP signalling;

FIG. 9 shows an embodiment of the invention showing IP peering and data traffic;

FIG. 10 shows an embodiment of a regional data centre;

FIG. 11 shows an arrangement for direct interconnect with an MNO;

FIG. 12 shows an architecture with multiple GRX provision;

FIG. 13 shows an arrangement for service interconnect;

FIGS. 14 to 16 show reference call flows;

FIG. 17 shows further aspects of signalling design;

FIG. 18 shows an arrangement for SIP connectivity;

FIG. 19 shows a generalised flow for mobile number portability;

FIG. 20 shows a message model for mobile number portability;

FIG. 21 shows a generalised process flow for mobile number portability;

FIG. 22 shows a reuse template for mobile number portability;

FIG. 23 shows a number classification table;

FIG. 24 shows a schema for number classification;

FIG. 25 depicts modification of a schema for number classification; and

FIGS. 26 to 28 show different models for defining a GGSN for an AP.

### DETAILED DESCRIPTION OF PREFERRED EMBODIMENTS

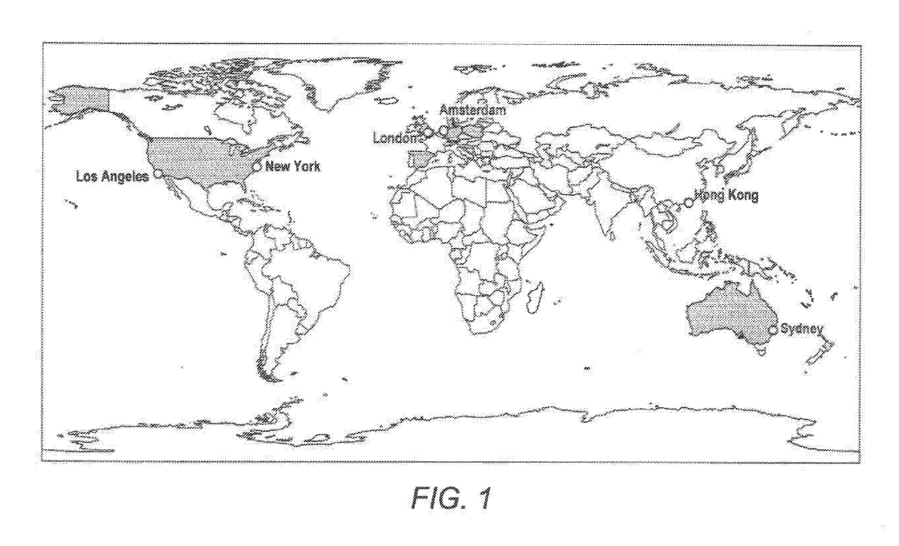

FIG. 1 shows an exemplary arrangement of a mobile phone network which extends across a number of countries, together with data centres associated with the network. Data centres are present in London, Amsterdam, Hong Kong, Sydney, New York and Los Angeles—these data centres in the embodiment described have regional and/or global functions (purely national data centres are not shown). These support national networks in a plurality of countries, typically by interaction with local operators in those countries. As will be described below, different data centres may provide different functionality, with some data centres acting as local data centres supporting only one national network (or possibly a plurality of national networks for one country), some data centres acting as local data centres supporting national networks in more than one country, and at least one data centre acting as a global data centre to support all networks for at least some services. A single data centre may have multiple roles—it may for example act as a local data centre for some purposes, a regional data centre for other purposes, and a global data centre for other purposes.

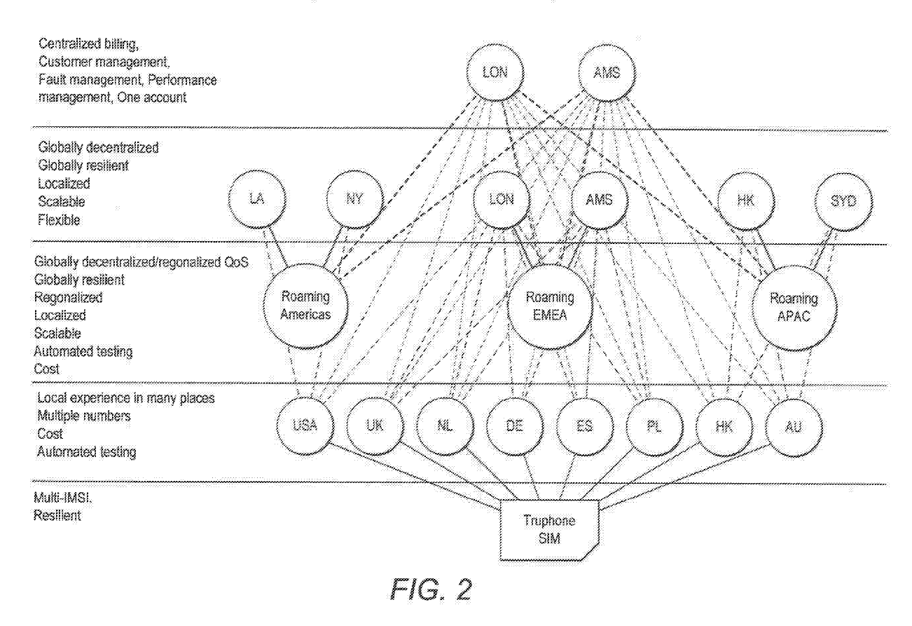

This division of tasks is shown in more detail in FIG. 2, which shows a logical distribution of network assets to support a worldwide mobile network. As can be seen from FIG. 2, in this embodiment the London and Amsterdam data centres act as global data centres, supporting OSS and BSS functions that do not affect latency for individual communications. These functions may include centralized billing, customer management, fault management and performance management. All six data centres act as regional data centres, providing the basis for a globally decentralized and globally resilient network. This allows functions to be localized to a region where this is appropriate, and also allows scalability and flexibility to the network by allowing new data centres to be added at the regional level when demand becomes sufficiently high and by allowing support to be switched between one regional data centre and another when this supports the demand most effectively.

As is shown in FIG. 2, these regional data centres may be used to support roaming in different geographical regions. In this case, the Los Angeles and New York data centres support roaming in the Americas, the London and Amsterdam data centres support roaming in EMEA (Europe, Middle East and Africa) and the Hong Kong and Sydney data centres support roaming in Asia Pacific. These data centres interact with national operators—these may be different national operators in each geography, and may include multiple operators in single geographies. While the global and regional data centres (and preferably a dedicated backbone between them) will typically be under common control, the national operator networks will typically not be. A subscriber SIM (preferably provisioned according to the approach described in the applicant's earlier WO 2011/036484) may be provided with IMSIs to access these multiple national networks, all these IMSIs being associated with a user account associated with the global network comprising the global and regional data centres.

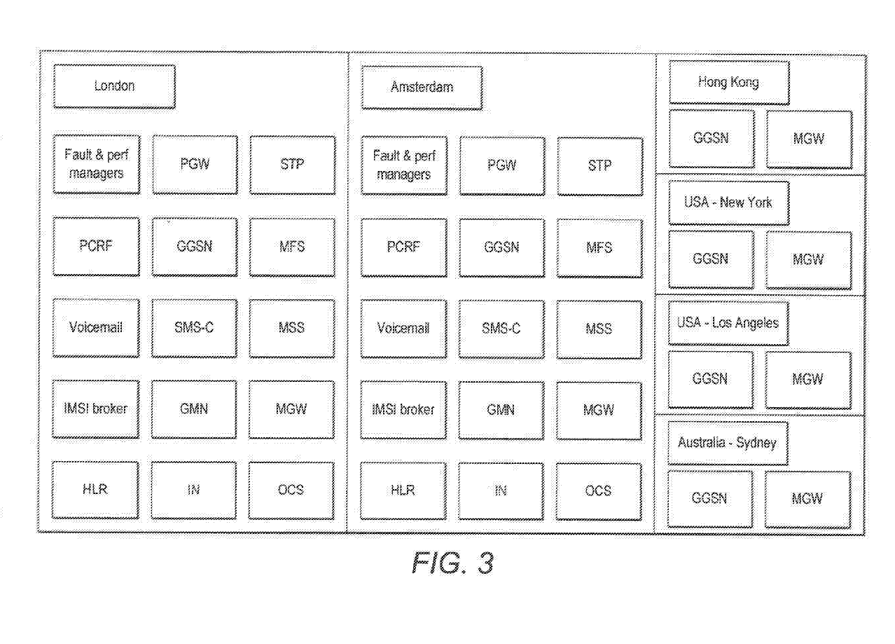

FIG. 3 provides an indication of the functions provided by the global and regional data centres. A full range of OSS and BSS functions are provided at the two global data centres in London and Amsterdam, including network functions such as provision of a Home Location Register (HLR). The provision of these functions at each global data centre provides redundancy in the event of failure. The regional data centres in this embodiment are provided only with a more limited set of functions to support regional communications traffic—these are a GGSN (Gateway GPRS Support Node) to enable switching between GPRS networks and packet switched networks such as the Internet and a MGW (Media Gateway) to convert digital media streams between different network types. Provision of these functions regionally rather than globally avoids latency issues that would arise if these functions were provided globally. The main signalling control nodes are located at the global data centres, but the media processing nodes are located close to national networks and local exits to the Internet.

In the specific arrangement shown, policy and charging control nodes (PCRF and OCS) are located in the global data centres. It is logical to collocate these with BSS and CRM (Customer Relationship Management) systems as these are deeply connected. Other backend interfaces may most conveniently be provided in the global data centres. In addition to media processing nodes, certain other control nodes that are relevant to geographical location may be located at the regional data centres.

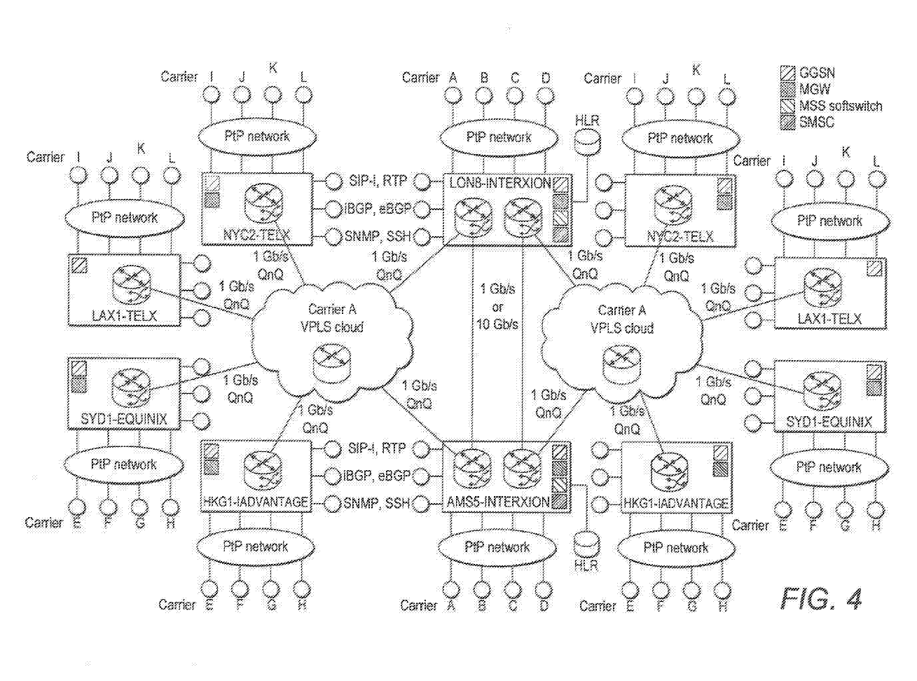

Control and signalling traffic exchanged between the global and regional data centres (for example Gx and Gy interfaces) is transported by a common backbone—an exemplary backbone arrangement linking data centres is shown in FIG. 4. FIG. 4 also shows the connectivity between network elements that provides the redundancy and scaling service for the network. OAM (Operations, Administration and Management) traffic is sent to a global data centre, where OAM platforms are located. All required traffic connectivity is realised through the common backbone. This may be provided as a virtual private network, such as a VPLS. In the arrangement shown, two main carriers provide actual physical connectivity in each data centre for redundancy. All types of traffic requiring inter-data centre crossing are linked except for key database synchronisations (HLR, online charging systems), which are provided with dedicated connections. External interconnects are provided in a hub and spoke model at each data centre. Traffic may be segregated inside the backbone using different VRF (virtual routing and forwarding).

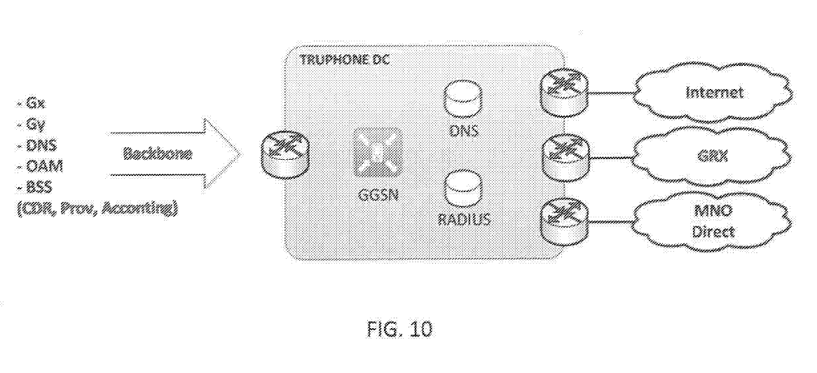

FIG. 10 shows a typical composition for a regional data centre, which can also be considered a remote Mobile Packet Core. Centrally provided services such as policy and charging are provided over the backbone from a central (or possibly another regional) data centre. The data centre itself comprises a GGSN and other network elements appropriate to provide in a regional geography rather than centrally. The regional data centre then provides local Internet, roaming via global roaming (GRX) and direct operator connections (MNO Direct).

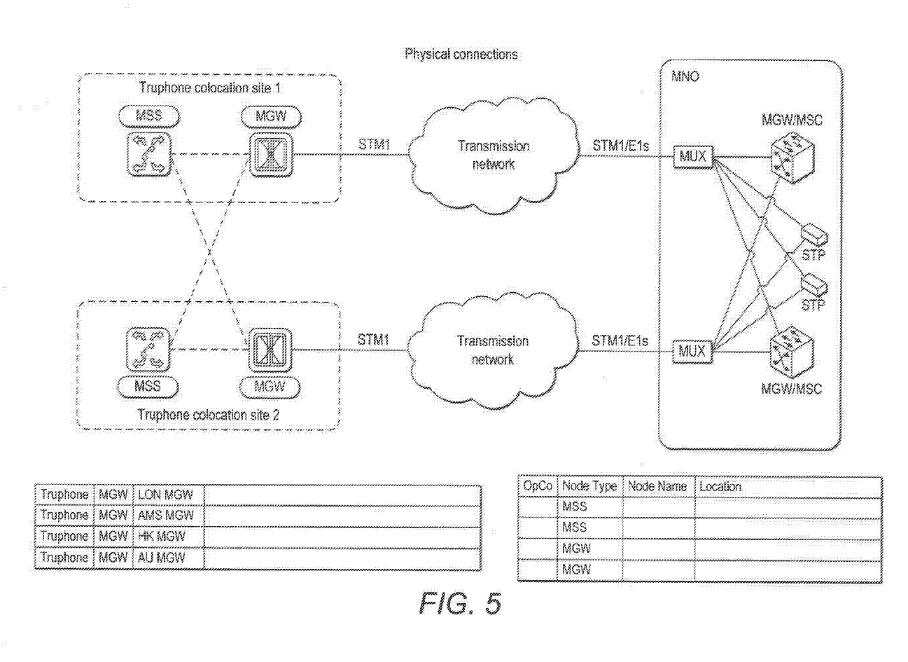

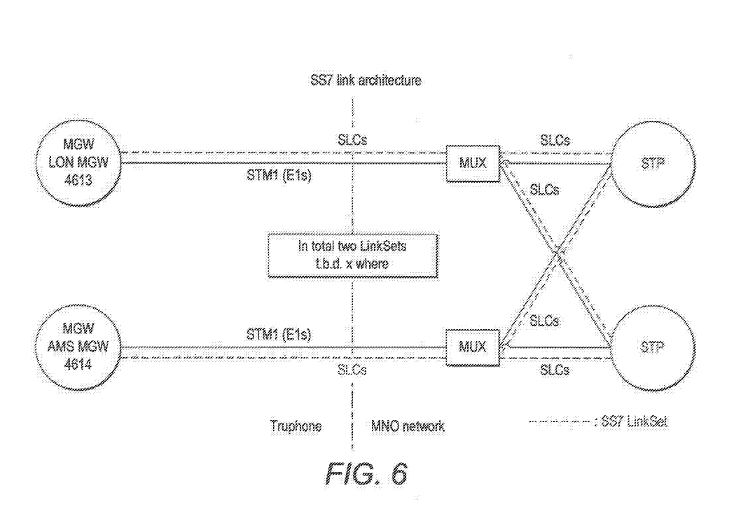

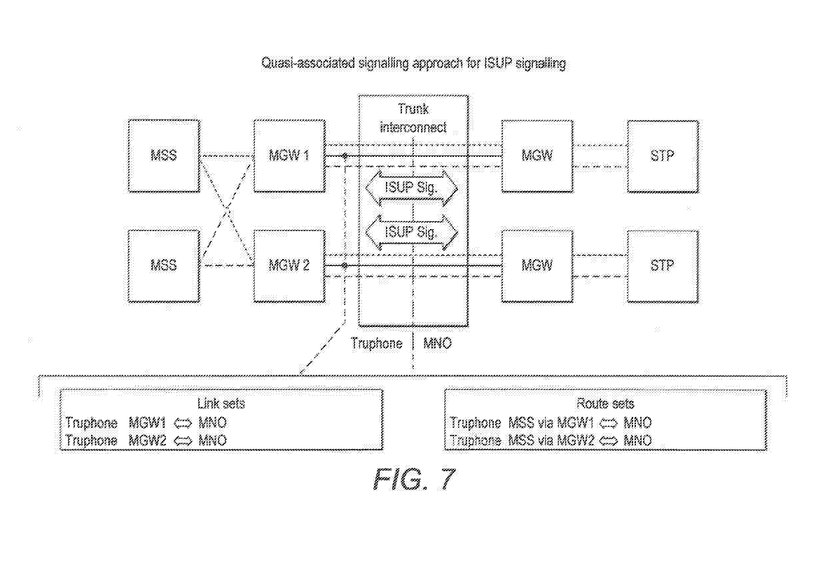

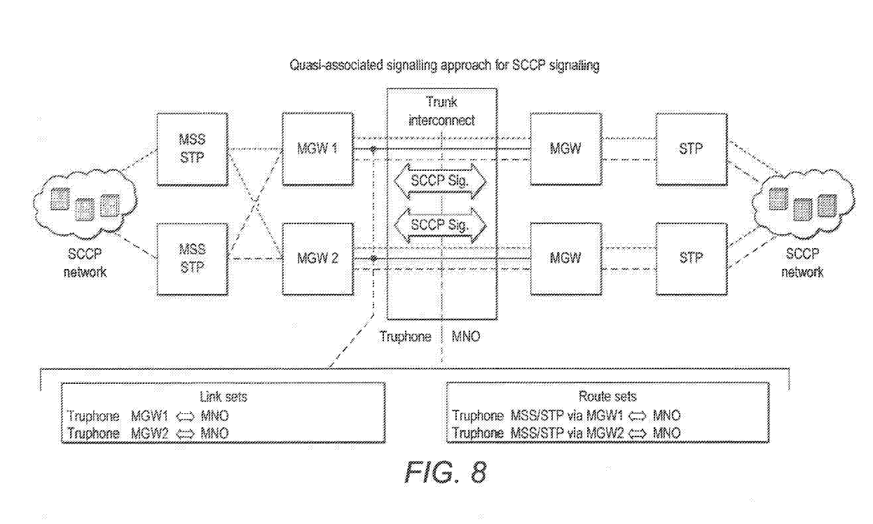

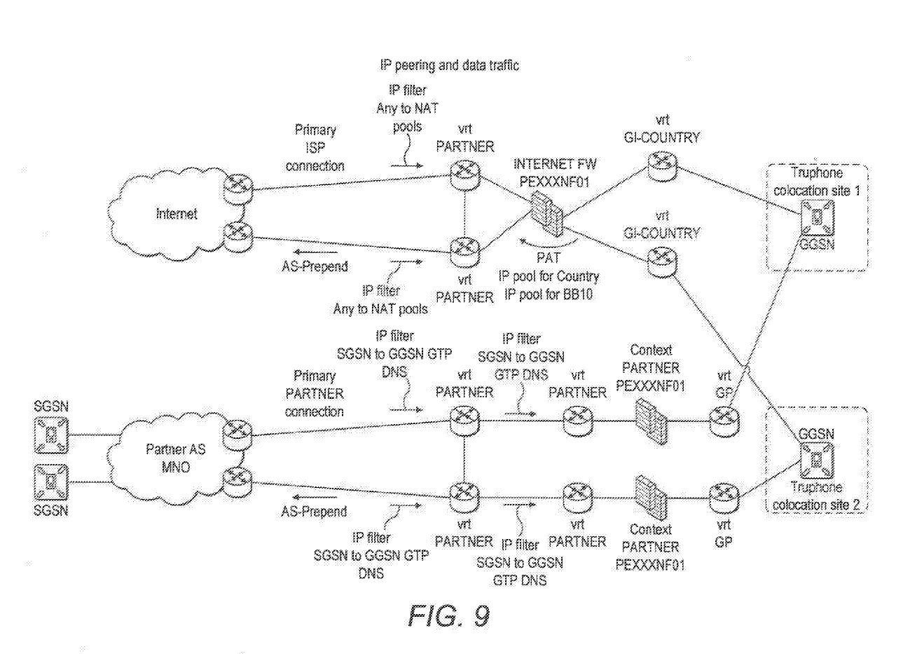

FIG. 5 shows one connection arrangement for voice—this is a direct connection between a regional data centre and an MNO (mobile network operator). As can be seen, different regional data centres can connect into the MNO through appropriate switching and transmission networks, so that the MNO can be supported by more than one regional data centre if necessary. FIGS. 6 to 8 show alternative interconnection arrangements for voice. FIG. 6 shows an SS7 link architecture showing connection between the global data centres and individual SS7 STPs (Signal Transfer Points). Associated ISUP (ISDN User Part) signalling is shown in FIG. 7 and SCCP (Signalling Connection Control Part) signalling is shown in FIG. 8. FIG. 9 shows a connection arrangement for data.

Aspects of an exemplary network arrangement and of exemplary signalling arrangements will now be described in more detail.

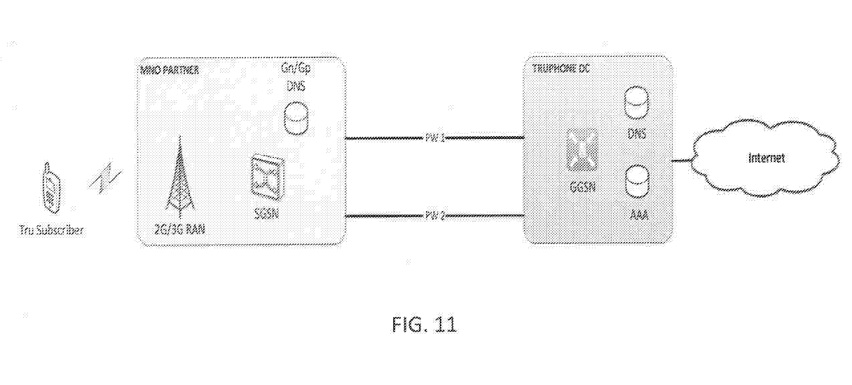

A number of different access interconnects may be provided. A preferred approach is for a direct interconnect with an MNO, as shown in FIG. 11. In the arrangement shown, all data exchanged between the CNO (Core Network Operator—responsible for global and regional data centres) and the MNO, be it Control Plane or User Plane related, goes over the direct interconnect links. The links, for redundancy purposes, may be from different third party providers, and may implement a BGP/IP peering between the operators. Preferably each MNO is connected to two different CNO data centres for redundancy, as described above.

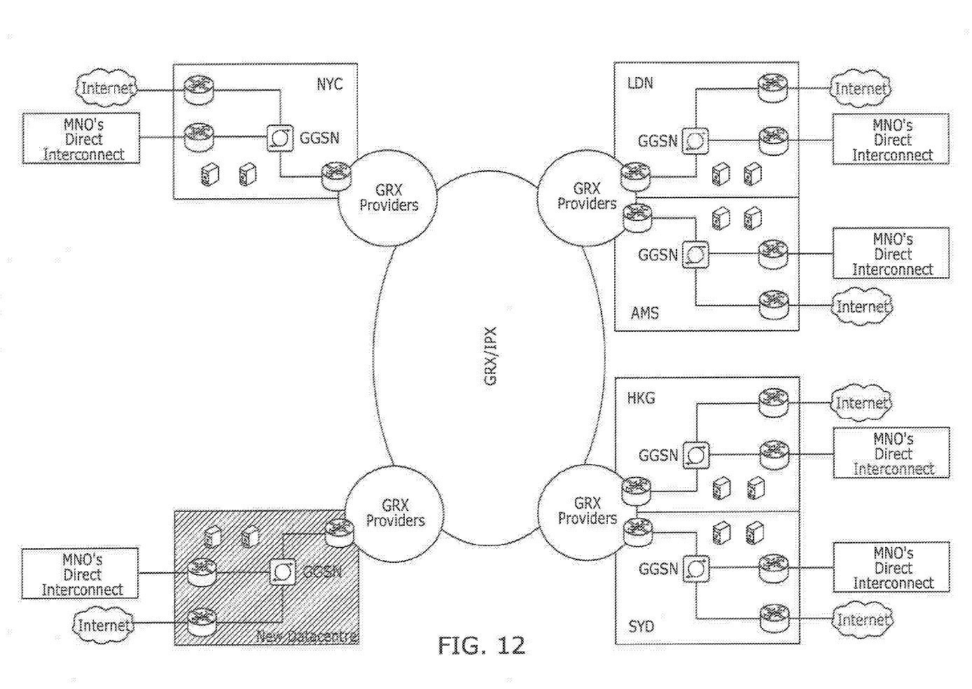

Other arrangements available may include sponsored roaming (which may be operated by an MVNO—Mobile Virtual Network Operator—without its own numbering range but using an IMSI sub-range provided by a sponsor), or roaming using a GRX hub provider. GRX has been specified by GSMA as the regular way of interconnecting GSM operators, for standard international roaming. Operators announce their identifiers and numbering plans to other operators through documents called IR21's. The actual infrastructure for this “many-to-many” interconnect is provided by carriers, working as hubs. FIG. 12 shows a high level architecture with multiple GRX provision.

Service interconnect is relevant to Interconnect connectivity and also to private data networks such as the BlackBerry network. Interconnect connectivity is provided by the Mobile Packet Core—it is made available to mobile users by the GGSN, but is implemented by the core backbone.

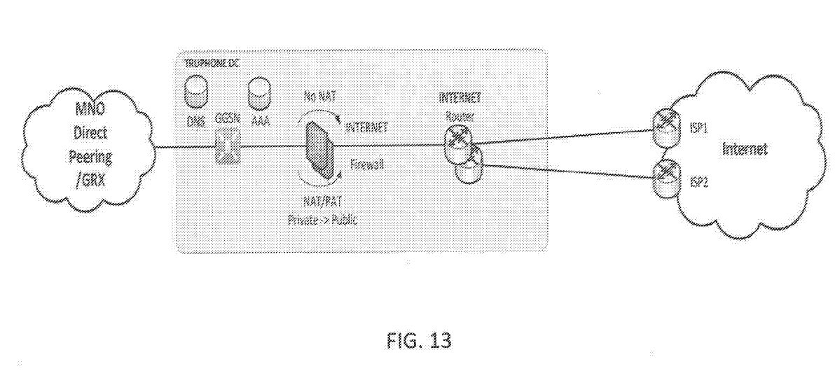

The arrangement for this is shown in FIG. 13. Each data centre has its own connection to the Internet, usually provided by two local ISP (for redundancy purposes). This means there need not be any Gi interface transport over the backbone between data centre sites. This reduces latency of access and backbone bandwidth requirements, and simplifies topology.

Connection to the local ISPs is implemented over direct interconnections implemented by the core backbone. The CNO public IP address space is utilized in these connections. NAT/PAT for mobile user access is also performed, if required by the core backbone, before traffic exits to the Internet. Internet DNS service is performed by the local ISPs, so the CNO does not require internal DNS for internet address resolution.

With this topology, the CNO provides local internet access where GGSNs are present. To support local internet access expectations, measures may need to be taken to provide services based on indication of locality. For example, a Polish user might expect when accessing the Internet to have Google (or other web site providers) to automatically re-direct its access to Polish language. This will typically be done based on the IP address of the user.

For BlackBerry connectivity, it is necessary to achieve peering with BlackBerry POIs. This may be done in a number of ways, such as by direct interconnect, by IPX interconnect, or by GRE tunnelling.

Individual network elements will now be described. The GGSN may have a built-in Policy and Charging Enforcement Function (PCEF) according to 3GPP TS 23.203 and 29.212, for which the main functionality is to support event triggers, report traffic statistics (for example, volume, time) and to apply QoS and as instructed by the Policy Control Server (the Policy and Charging Rules Function, PCRF). Local rules may also be configured, and a Service Awareness capability used to detect which service is being used so that policy and charging can be applied at data flow level. Policy enforcement such as dynamic bearer QoS management, service and data flow gating and traffic redirection on both L3 and HTTP level may be provided. Full internal hardware redundancy may be used to support resilience, for example by switchover between multiple service blades using an active/standby redundancy model. This may be based on recovery groups that contain an active/standby recovery unit pair. Recovery groups are used to control resources (for example, disk file systems or IP addresses) that can be linked to recovery groups. When, for example, an IP address is linked to a recovery group, it becomes a movable resource that the high availability services (HAS) functionality controls and allocates to the recovery units. The currently active recovery unit within the recovery group owns the movable resource, and if the active recovery unit fails, the functionality of the movable resource is switched over to the standby recovery unit. In order to ensure redundancy and traffic continuity, each type of traffic will be placed in two VLANs, configured on separate ports.

Other network functions, such as APN resolution and AAA services, may be provided by servers located at the regional data centres. Redundancy may be supported by hardware or at the service level.

Policy control and charging are provided at the central data centre(s) and preferably also use fall hardware redundancy (OCS is more complex, involving a network of interconnected systems which may use multiple strategies). Other services such as network backup may be provided centrally.

Service redundancy is also important, and is achieved by planning for failover scenarios including network element failure, interconnect link failure and site failure. Typically, service failover will involve a change of data centre in provision of the service. This is achievable with this architecture as Mobile Packet Data Service is realized, for session/bearer establishment independently, in each GGSN location.

Redundancy at the Gp interface is also desirable—this is the interconnect interface between the Core Networks (PS Domain) of two different Operators. It interconnects the Visited network (SGSN) and the Home network (GGSN for the CNO discussed). It involves a DNS interface, used by the Visited SGSN and/or DNS, to query the Home DNS for APN resolution (basically the choice of GGSN that will provide the service). This query is either routed through GRX or through the direct interconnect links to the MNOs—APN resolution will be different in both scenarios. Because of this, each of the two DNS servers in each data centre belongs to a different DNS cluster. After the APN resolution, a GGSN is selected to handle that particular PDP. The selection of GGSN depends on the DNS that is interrogated, and the call scenario in question. Redundancy is achieved through configuration based on user IMSI, access type and DNS configuration.

Redundancy over the Gi interface is realised for data services. Internal redundancy is provided at the GGSN level, with connectivity with local ISPs assured by the core backbone at the connectivity level using redundant geographical endpoints and different link providers. For Internet DNS service, the ISPs DNS servers are reused, configured in service APN. Each ISP provides two DNS servers for redundancy. Internet access is preferably always provided co-located with the serving GGSN, even in failover scenario—this means that there need be no internet traffic transferred between data centres through the backbone.

Redundancy is provided at the Gy interface (for online charging of Mobile Packet Data services) and at the Gx interface (for policy control of Mobile Packet Data services) using active/active or active/standby configurations in the two global data centres.

Provision of network services will now be described. Mobile Data Service is realized over service Action Points (APs). These are identified by its name, hence Access Point Name (or APN). The APN defines the GGSN processing the service, as well as the service characteristics being provided. These characteristics include: routing instance selection; IP address allocation to user equipment (IP Pools); authentication; accounting and charging; policy enforcement; bandwidth and QoS control; and access control.

The APN is configured in the subscriber profile in the HLR, and delivered to the SGSN on successful PS Attach. It is then used by the user equipment to request a data session (PDP context), validated by the SGSN according to the profile received from the HLR, resolved via Gn/Gp DNS, and thru GTP signalling passed to the GGSN, who then processes the request together with other Core Network elements, like OCS and PCRF.

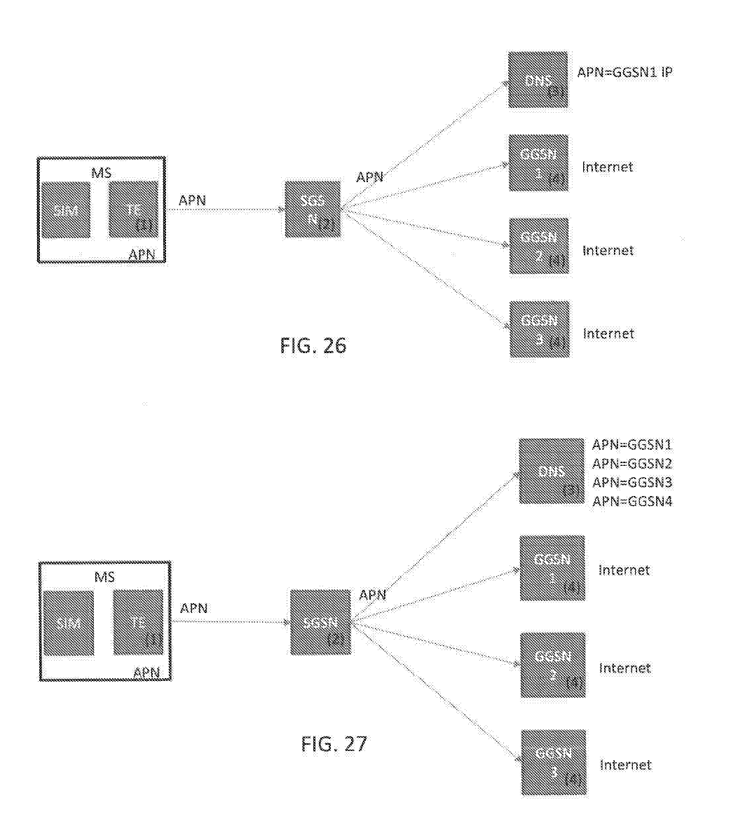

FIGS. 26 to 28 show different models for determining a GGSN for an APN.

In the FIG. 26 arrangement, when the mobile station (MS) registers on the SGSN, the HLR provides it with the APN allowed for it. The TE (trusted element) of the mobile station selects the APN for the MS to request PDP (Packet Data Protocol). The SGSN resolves the APN from the HPLMN DNS (indicated as 3) to know to which GGSN the PDP session should be established. Here, this is automatically resolved to GGSN 1, the GGSN accepts the PDP and access to the internet is established. This approach does not allow for intelligent selection of the GGSN (for example, based on MS location).

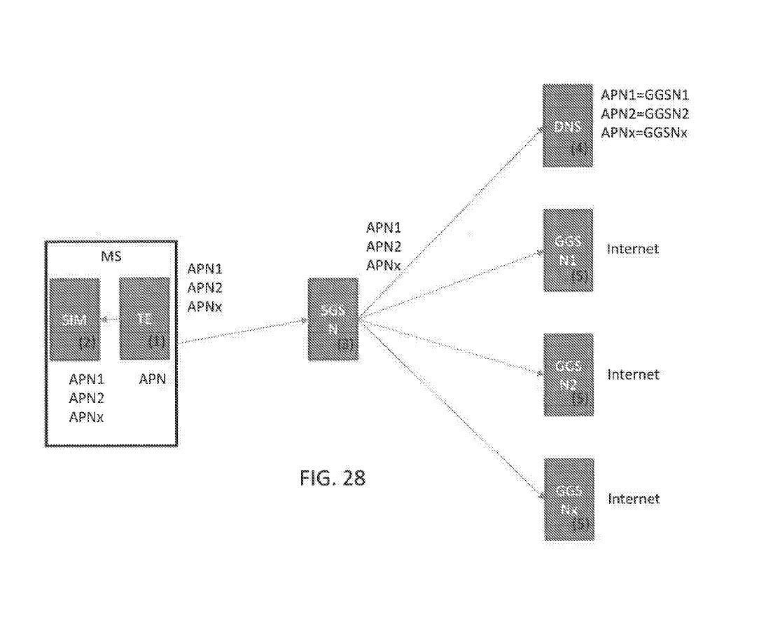

In the FIG. 27 arrangement, when the mobile station (MS) registers on the SGSN, the HLR again provides it with the APN allowed for it. The TE (trusted element) of the mobile station selects the APN for the MS to request PDP (Packet Data Protocol). The SGSN resolves the APN from the HPLMN DNS (indicated as 3) to know to which GGSN the PDP session should be established. This is not automatically resolved to GGSN 1—it uses DNS Views and zones to select a GGSN according to the SGSN from which the request originates. The chosen GGSN accepts the PDP and access to the internet is established. This approach does allow for greater flexibility and a more appropriate choice of GGSN based on the requesting SGSN.

In the FIG. 28 arrangement, when the mobile station (MS) registers on the SGSN, the HLR provides it with a group of allowed APNs, here shown as APN1 to APNx associated with a trusted element APN. The TE reports and checks with the SIM if a data session with the original APN can be established, and the SIM is programmed to map the original APN to any of APN 1 to APNx depending on configuration criteria, such as the network on which the MS is registered. The MS then submits the PDP request with the translated APN, the SGSN resolves the correct APN from the HPLMN DNS to identify the correct GGSN, and access to the internet is established as before. This model is preferred, as it allows selection of GGSN from any suitable parameters derivable from the SIM or in the mobile equipment. It also gives the HPLMN more control when there are specific roaming preferences or agreements in operation—this can allow, for example, regionalisation of data traffic by using a US GGSN for all data traffic in the North American region.

The APNs name is chosen to indicate a particular service the user has subscribed to, and needs to be known by different platforms involved in the authentication, authorization, accounting and charging, and session control.

The GGSN may support Service Awareness functionality allowing for both SPI (Shallow Packet Inspection) and DPI (Deep Packet Inspection) as applicable under PCC rules. Mobile Packet Data service may provide the bearer for MMS. Lawful Interception may be provided for data services at the GGSN if required. Policy control and charging are handled at the GGSN with external servers using the Gx and Gy interfaces respectively.

The architecture described above can readily be modified for a network using LTE. LTE uses a Home Subscriber Server instead of an HLR—the HLR can be replaced by an HSS or the two may be implemented in parallel. The architecture may also be readily updated to support the LTE data roaming paradigms of Home Routing and Local Breakout. Similarly, this architecture may be readily adapted to support IPv6.

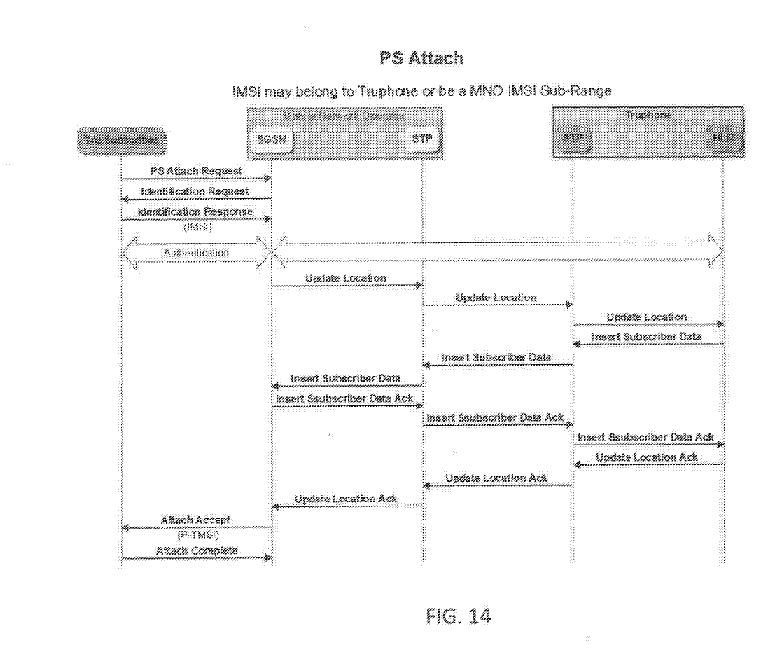

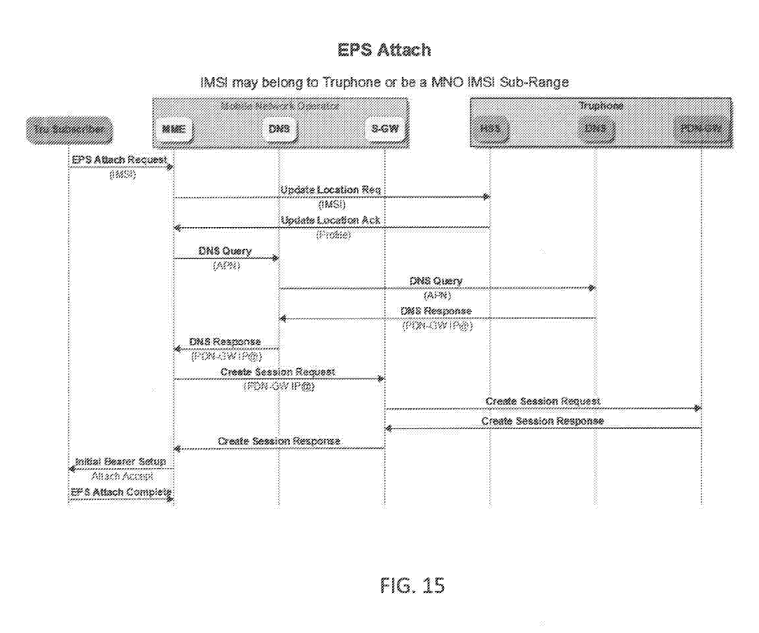

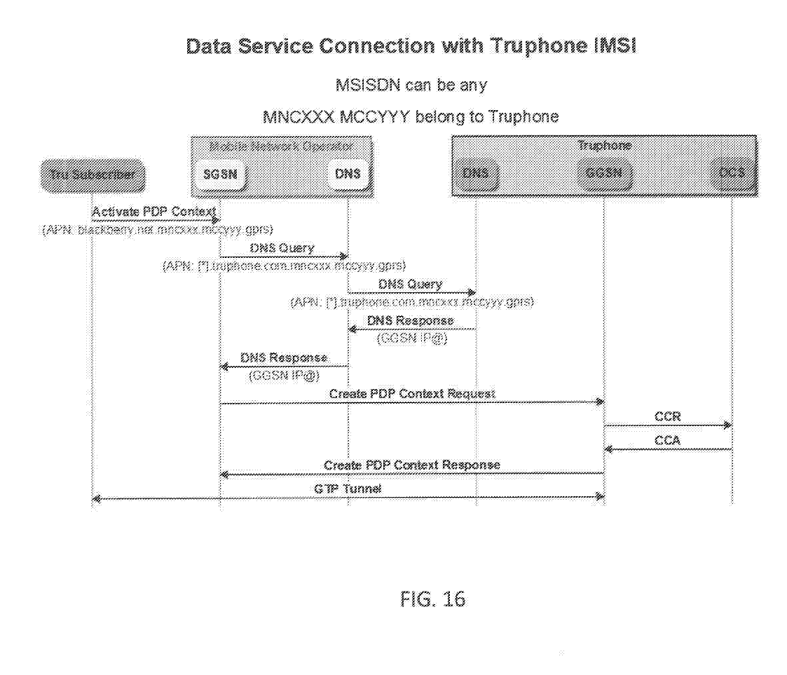

Reference call flows are shown in FIGS. 14 to 16.

Further aspects of the signalling design are described further below. Two types of network nodes are response for signalling: MSS (MSC Server System) and STP (Signal Transfer Point)—these are shown in FIG. 17. These are responsible for Voice ISUP and mobility signalling (SCCP). The SCCP routing is required for Location Update response from the HLR of the CNO towards the MSS of interconnect partners' network where the CNO subscribers will perform Location Update. The control plane between MSS and MGW consists of H.248/MEGACO and M3UA/SIGTRAN. The H.248 interface is used for resource control and other management functions between MSS and MGW where MSS has the MGW control function. The SIGTRAN interface is used for routing the signalling messages between MSS and MGW where MGW acts as a Signalling Gateway between MSS and any external network element.

ISUP protocol is used for connection to different networks. Signalling routing to National and International Interconnects will be on Global Title for SCCP traffic and on SPC for ISUP traffic.

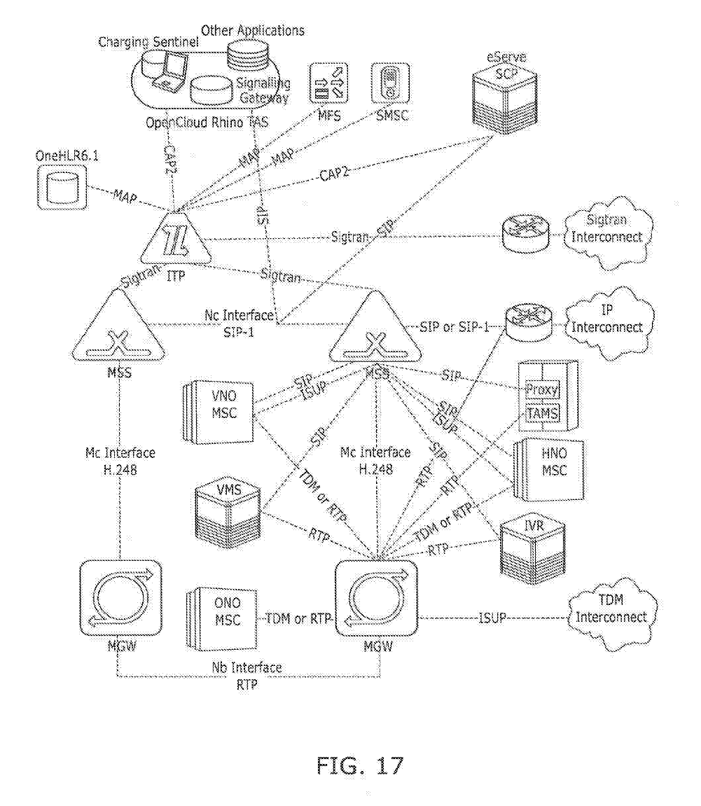

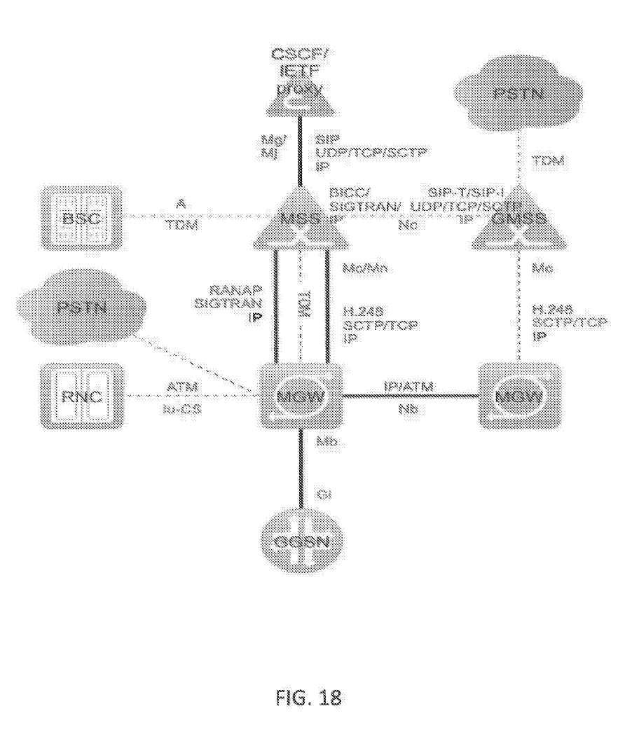

Session Initiation Protocol (SIP) may be used to create and manage multimedia sessions between two or more participants. The general aim of SIP is to support Voice over IP (VoIP) and to ensure that future VoIP services be fully Internet-based. This may operate with other MSC Server (MSS) features and implements the Media Gateway Control Function (MGCF) in the MSS. SIP connectivity is shown in FIG. 18.

SCTP (Stream Control Transmission Protocol) is the layer above the Physical IP layer which will be carrying both the M3UA and H.248 traffic. The MSS and STPs acts as a SCCP gateway in most of mobility related events. The SCCP traffic originating from MNOs will be forwarded to internal service platform elements based on Global Title (GT) translated to a Destination Point Code (DPC) and Sub-System Number (SSN).

Thus, two main tasks need to be carried out to create a proper SCTP layer between MSS and MGW. These are creation of SCTP parameter sets for H.248 and M3UA with similar parameter values in MSS and MGW, and creation of SCTP multi-homing for the signalling units in MSS and MGW. Multi-homing will be used in all SCTP associations. A host is multi-homed when it can be addressed by multiple IP addresses. The SCTP can use both interfaces in such a way that one is working as primary and the other as the secondary path. Usually the signalling traffic goes via the primary path, and if failure occurs, the SCTP will start resending the unacknowledged messages via the secondary path. This ensures that no messages are lost if one of the paths is broken.

The interconnect strategy for following is as follows.

For an MNO connected over IP interconnects, IP Interconnects are connected to the MSS for control plane by SIP and to the MGW for user plane by RTP, with Mobility SCCP routing traffic based crated to SS7 over an IP “SIGTRAN” link between CNO and partners' network.

For an MNO connected over TDM interconnect, TDM Interconnects will be connected to the MSS control plane using ISUP signalling. El connections over STM-1 will be established in the MGW for user plane functions. TDM Interconnects will have signalling connectivity to MSS through the MGW which acts as a signalling gateway. Mobility SCCP routing based on Global Title will be created towards the interconnect partners' network. SCCP routing is required for Location Update response from the CNO HLR towards the MSS of interconnect partners' network where the CNO subscribers will perform Location Update. Signalling in the MGW is controlled by the MSS over SIGTRAN. It is provided over Interface Signalling Units called (ISU) configured in MGW. TDM Interconnects will have signalling connections to the MSS using the MGW as signalling gateway.

The signalling interface between MSS and MGW is Mc interface. It has two main signalling functions such as H.248 and SIGTRAN. In Truphone, the Mc interface is designed in such a way that both MSS have H.248 and SIGTRAN interfaces to all six MGWs connected through the core backbone. H.248 is carried over the Stream Control Transmission Protocol (SCTP) which provides “Multihomed” connection between MSS and MGW. This ‘Multihoming’ provides two discrete paths via the use of two IP addresses in two IP Subnets at each end of the connection. It is employed to provide resilience on the Mc interface and is carried over IP. SIGTRAN associations will be created between MSS and MGW for NA0, NA1 and IN0 for the purpose of TDM Interconnect. There will be two SCTP associations for every IP signalling linkset with the MSS acting as server and the MGW acting as client.

Nc interface is the interface between MSS elements. It works on SIP-I and BICC and it is based on control part. No user plane is involved in this interface. Network-to-Network based call control signalling is performed over the Nc Interface between the MSS. An alternative call control protocol in IP-based network that can be used in NSN MSS is Session Initiation Protocol with encapsulated ISUP (SIP-I). It provides similar trunk-like signalling capability as provided with BICC. In MSS, SIP-I is used as a tunnelling method for ISUP messages.

The user plane interface between the MGWs is the Nb interface. All MGWs in regional data centres are connected over IP interfaces through the core backbone by RTP which is used for user plane data transfer. Nb interface relates only to user plane information between MGWs and does not have any control part attached to it.

The SS7 network is provided with IP Transfer Points which are nodes are responsible for signalling gateway functions and implementation of hierarchical and centralized routing in order to give complete MTP2 and MTP3 signalling solutions. The STPs have fully redundant solution with dual site full mesh configuration till network elements in order to ensure failover. The network plane used for the SIGTRAN links between each MSS and all the STPs in NA0.

SIGTRAN links between MSS and STP pairs is based on the SCTP associations between signalling units in MSS and signalling units at STP end. There will be two SCTP associations between each MSS and an STP within an STP pair. The M3UA role of MSS will be client and that of STP will be server.

The MSS are connected to STP pairs located at the global data centres. The signalling between MSS and STP is based on SIGTRAN using the CNO IP network. MSS do not have direct physical signalling connectivity to service platform elements. SIGTRAN interface from MSS to STP pairs will be used mainly for the MSS nodes to communicate with service platform elements and vice-versa. The signalling route between MSS and STP is the Layer-3 functionality of the signalling interface between them. The signalling route between the MSS and STP may remain the baseline for the signalling route between MSS and service platform elements. The configuration of signalling route between MSS and STP may be similar to signalling route configuration of any internal network element.

The Charging Sentinel is a platform to realize the SCP functions—in this embodiment it is based on the Opencloud Rhino Telecom Application Server (TAS) and is used to realize the IN-SCP functions. The CS is used to implement CNO services such as the Smart Dialling and Smart CLI service, as well intelligent call routing functions. The interface to the Core Network is 3GPP CAP and to OCS uses diameter and HTTP. Subscriber profiles are stored in the OCS database and retrieved as needed during the call setup.

The Rhino TAS has a SIP/ICS interface with Core Network, used to support USSD callback functions. The failover strategy deployed by the CNO is similar to that used for the MSSs with a full mesh inter-site configuration without a single point of failure. In an exemplary arrangement, the CNO is using to CAP2 protocol for termination and TSANned voice calls and SIP/ISC for the purpose of USSD callback service call setup.

An external partner's IVR will be directly connected to the MSS using SIP and at the same time connected directly to MGW using RTP.

The MSSs are connected to HLRs in the global data centres via STPs. Each node will have SIGTRAN associations to a pair of network STPs. Each HLR has signalling point code and global title in order to ensure the correct routing. The HLR will have a SIGTRAN signalling stack, and each HLR will be physically connected to the STP pairs in the network. The CNO MSS routes the signalling towards the HLR via the STP. To ensure full mesh connectivity, the STPs will work as load share for any message sent to HLR . The inter-site mesh links can ensure if an outage occurs in a specific site and can reroute the signalling toward second and keep the service live.

The SMSC (SMS centres) are connected to MSS via the STP pairs. The signalling routing used between MSS and the SMSC is SCCP routing based on point code and sub-system number. Full mesh connectivity may again be provided for failover.

MSS to MFS signalling is provided via ITP. The Multi-Function Services (MFS) is a network element responsible for 3 services: MAP SRI Gateway; MAP PRN Fix; and MNP (Mobile Number Portability) DIPS. CNO mobile number portability may be provided in each global data centre.

Different default signalling carriers may be provided in different geographic areas. SIGTRAN may be used as the signalling protocol for interconnection. In order to increase resiliency, the CNO may have full meshed SS7 links over private IP peerings. These links may be created by M2PA over SCTP and the routing method would be GT in both calling and called party. The signalling carrier can be responsible for ANSI to ITU and ITU to ANSI conversion for relevant towards/from CNO ITPs.

An example of a service provided across such an architecture is mobile number portability (MNP). Mobile number portability between network operators is known, but different countries have different regulatory approaches, and different process flows. The present architecture lends itself to a structured layered approach with a common core process and regional adaptation. This allows for great flexibility and effective code reuse. As discussed below, this basic model is applicable to other services which have core elements common to all geographies but specific elements that are country-specific.

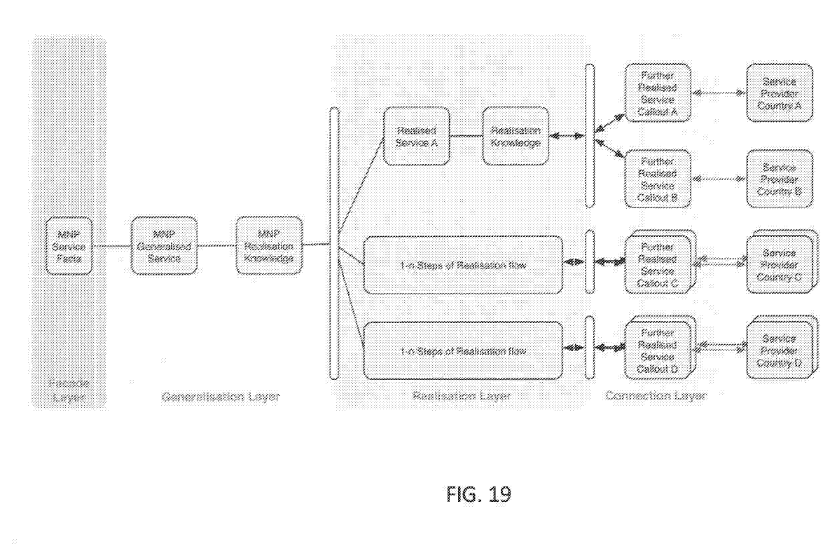

FIG. 19 shows a multi-layered service architecture that allows MNP processing to be isolated while applying common processes where possible. Complex integration issues specific to local geographies can be isolated to those geographies (and so, for example, carried out at a relevant regional or local node rather than at the central node).

The first layer (Façade Layer) is a service fascia or API that exposes MNP functionality to other systems and processes. This layer isolates MNP functionality and complexity inside the ‘MNP system’. This in turn ensures that other systems can treat MNP simply and consistently, only having to understand that there exists a system that will deal with all MNP processing regardless of what approach may be require for a given country. The MNP system need not have any knowledge of what external systems or processes may use its services—as long as a request is authorized and well formed the MNP systems will attempt to process it. By achieving the isolation of the MNP system it is ensured that the system is re-usable across any set of systems consuming MNP services and functionality.

The second layer (Generalisation Layer) contains common or generalised functionality—functionality that is common to all MNP approaches. To reduce complexity and maintenance overhead this common functionality should be implemented only once. This implementation should be considered ‘central’. This layer interacts with the Facade Layer (in fact it may implement this layer) and the Realisation Layer described below. The Generalisation Layer integrates with the Realisation Layer through a single integration structure. While the Generalisation Layer handles all functionality in some sense, where a particular area of functionality varies due to approach specific or country specific handling then the functionality presented in this layer is simply a wrapper for functionality achieved in subsequent layers—a standard information set is used to represent the function but it is passed through to the other layers for processing. For example: Overall state management (e.g. where in the process of performing a Port is a particular request) is common to all approaches to MNP (although the state values themselves may differ). It would therefore be handled in the Generalisation Layer.

The third layer (Realisation Layer) contains functionality that is specific to the small number of generalized approaches to MNP. Each generalized approach has its own ‘component’ implementing functionality specific to the approach. The Realisation Layer integrates with the Generalisation Layer through a single interface structure. Each approach specific component in the Realisation Layer integrates to the Connection Layer (discussed below) with an interface structure specific to that component. The components within Realisation Layer do not understand the specifics of how any given country that uses the generic approach associated to the component implements that approach. It is possible that for some approaches no specific processing or functionality must be achieved in addition to that in the Generalisation and Connection Layers. For example: The United Kingdom implements MNP using a ‘Authority Code Approach’ where an authorizing code is passed between network operators. This ‘code approach’ is also used in a small number of other countries worldwide. A component would exist in the Realisation Layer that provides the functionality and processing required to implement an ‘authority code approach’ to MNP Processing. This component would be used wherever a country implements a ‘code approach’ style MNP.

The fourth layer (Connection Layer) contains functionality that is specific to the country for which MNP processing must be performed. This includes integration to whatever external services and/or processes are required in that country in the data formats required for that country. The Connection Layer integrates to the Generalisation Layer through an interface specific to the MNP approach that the country implements. The components within the Connection Layer are entirely specific to the country that they service. For example: the United Kingdom specific interface handling and information content would be managed by a UK service call-out. This UK service call-out would be utilized by the ‘authority code approach’ component (because the UK implements an ‘authority code approach’ style MNP) and would achieve integration with a clearing house (the central communication point for UK MNP handling).

This approach will now be described in more detail with reference to a specific message model and process flow.

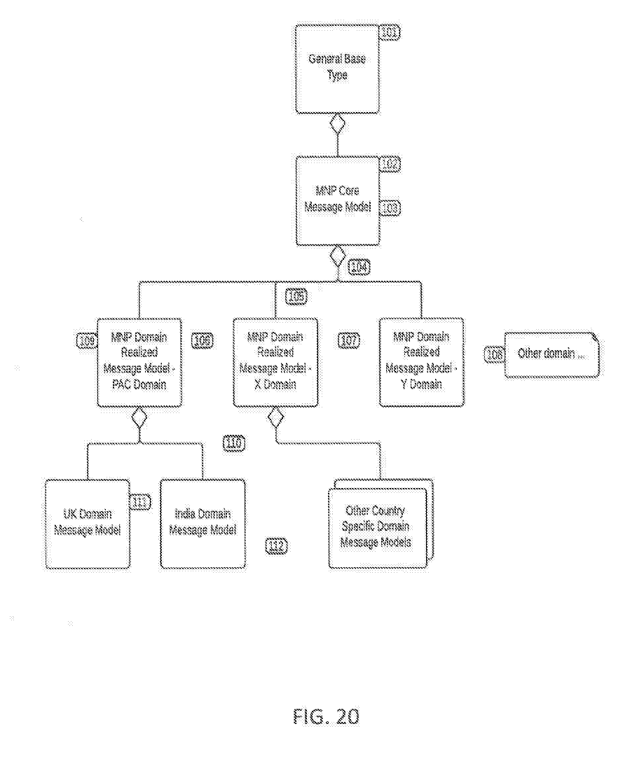

A hierarchical message model is shown in FIG. 20. This message model (MNP Framework) defines a hierarchical tree of canonical message models. This provides a polymorphic approach to dynamically dispatching messages to country specific service providers as follows:

The Base Types (101) are defined in the Facade Layer. This defines an abstract and clean layer of Types to support the Façade Layer. The Core Message model (102) is inherited from the Base Type. The interface defined in the Generalisation Layer will use this type. The Core Message Model provides the knowledge (103) of domain models used in the Generalisation Layer.

The knowledge (104) of each specific business domain in the Realisation Layer inherits the knowledge defined in the Generalisation. The inheritance provides a knowledge transfer path (105) so that we support both separation of domain knowledge concerns and avoid duplication of common concerns. The specific business domains in the Realisation Layer are in a polymorphism of knowledge regions—these business domains in the Realisation Layer are loosely coupled with each other and may be treated independently (the Port Authority Code domain—PAC Domain—is shown as one specific example)—however, they all inherit the knowledge from the Generalisation Layer. There may be more than one level of inheritance (108) in the Realisation Layer.

Country specific domains (110) are in the Connection Layer, and inherit knowledge from the business domains from the Realisation Layer. The knowledge in the Country specific domains are in an appropriate canonical format. There is an interface sitting in this Connection Layer to provide transformation between the actual Country MNO data format and a canonical country format. Proprietary knowledge may thus be shielded and decoupled from the outside world.

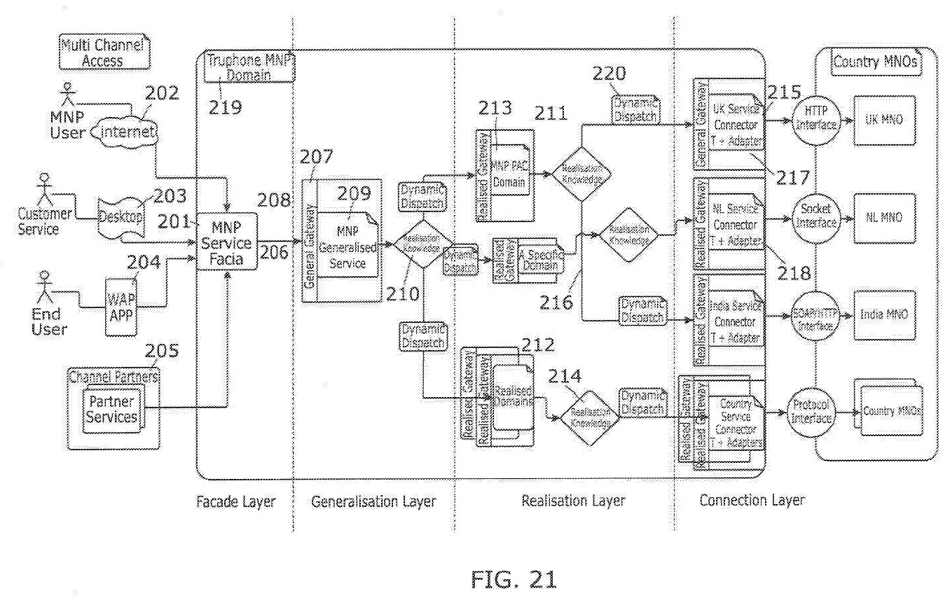

A generalised MNP process flow is shown in FIG. 21. The Facade interface provides a clean and unified interface (201) to support MNP requests from multichannel clients. Internet access may be through a web browser (202), a rich client using a desktop application (203), mobile access through mobile devices (204) or through channel partners (205). The Facade Layer will distribute (206) the request messages to the corresponding interfaces defined for the General Gateway in the Generalisation Layer. The General Gateway defines a general interface to accept a hierarchical tree of message payloads in divergent formats. The use of the General Gateway interface in the Facade Layer minimises the impact of internal changes to the Facade clients. This can be demonstrated in the following two examples: 1) changing of the interface or process flow of an existing Country MNO would have no impact to the clients invocation of the Façade Layer; and 2) adding a new Country MNO will not impact the existing client code but will give the client new capability to submit additional requests.

The MNP generalised service (209) uses the Realisation Knowledge [210] to handle the requests submitted through the General Gateway [208]. The Realisation Knowledge knows the next layer of business domain (but not the implementation details), and thus can dynamically dispatch the requests to the next realisation domain. The Realisation Layer contains 1 to n steps of realisation flows between the Realisation Domains. Each Realisation layer contains specific business domains, each of them has its own domain knowledge that contains domain models and provide the corresponding business process to do the domain logic. As indicated previously, an example of a domain is PAC (Port Authority Code) domain. Each Domain in the Realisation Layer has its Realisation Knowledge and can use it to dynamically dispatch the flow to the next step, which is either another level of specific domain or the Connector in the Connection Layer.

The Connection Layer contains a number of Connectors, each of them provide implementation details to connect to a specific Country MNO. The connection may be bi-directional. The flow from a specific domain to a Connector could be bi-directional as well, depending on the domain specific process flow. Each Connector contains a Transformation that transform a proprietary country canonical data model to/from the actual Country MNO data model. Therefore, internal proprietary knowledge is shielded and decoupled from outside world. Each Connector contains an Adapter to handle the connection implementation details. There is inheritance/extension relationship in the horizontal direction, thus the horizontal direction provides functions from common to more specific. The Horizontal direction provides a whole function flows to realise the Country Specific MNP function from end to end. The Realisation Domains are vertically decoupled from each other, thus can be pluggable with minimum impact to the whole framework. The domains have polymorphism vertically. The Country Connectors can be flexibly pluggable with minimum impact on the layers above. The connection between the Domains in the Realisation Layer to Connectors in the Connection Layer to the Country MNOs could be bi-directional.

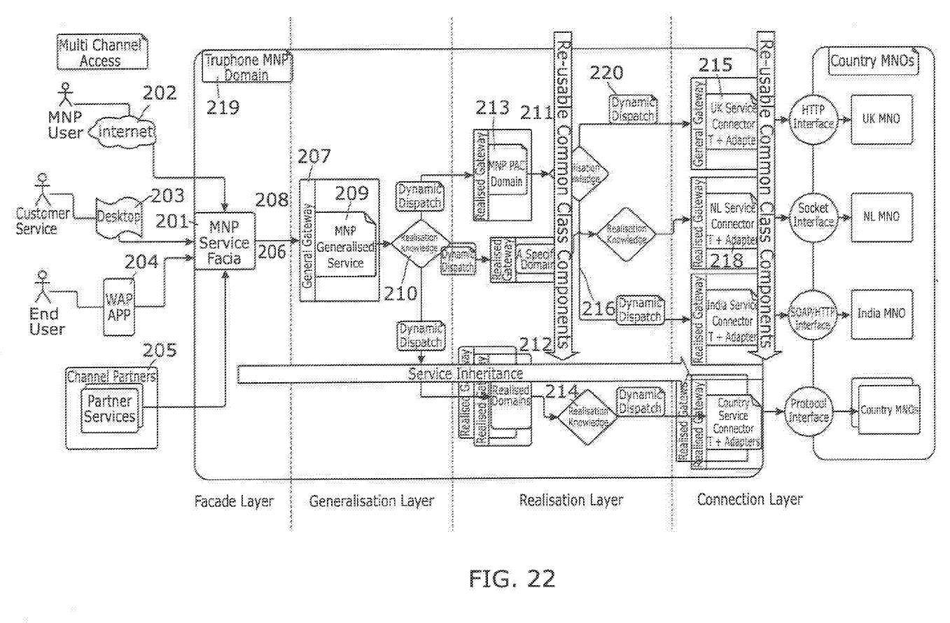

FIG. 22 shows how this approach implements inheritance and re-use. The four layer based framework offers great reusability with little knowledge dependency so that the implementation or modification of any Country specific MNO number portability can be plugged or unplugged in the most flexible fashion with minimum impact to the consumers of this framework.

The horizontal direction of this framework offers service inheritance and extension. A hierarchical tree of canonical message models for horizontal service contracts can be defined. A clean, simple general interface has been defined for the Façade Laywer which allows message data flows to be dynamically dispatched and enriched horizontally. The service business logical is continued and extended horizontally to handle the message flows. A typical example is the horizontal service flow for implementing the Authority Code Approach for a UK MNO. The MNP requests are dynamically dispatched and flow in the MNP PAC (Port Authority Code) Domain, which implements the Authority Code Approach logic, and then passed to the UK Service Connector, which transforms the canonical model to UK MNO data model and handles the low level transport details to do a HTTP post out to the UK MNO. After that, in order to implement another Authority Code Approach based Country MNO, for example India, it is only necessary to plug in a Country Specific Connector to handle the Transformation and Transport details. The updating and modification of the UK Connector would have no impact on the India MNO Connector, and vice versa. This provides horizontal polymorphism.

Vertically, the framework supports maximum reuse of common class components. The common functionality between the Realisation Domains or between the County Service Connector can be abstracted as a template. The an object oriented template design approach may be used. The template used vertically may offers the Capability of General Responsibility Assignment for common functionality. A typical example is the Session Management we implemented for the UK Connector. Instead of open/close session in each connection, a HTTP security session is cached and maintained for a number of HTTP Posts to improve the systems integration performance between a proprietary system and external systems. The Template design of the session management offers the vertically transparency to all the Country MNO Connectors suing the HTTP protocol underneath, for example, SOAP/HTTP, plain HTTP, or REST, etc. This provides polymorphism vertically.

Another service model using the same general approach is for Directory and Number Services. There is a similar challenge to address where numbers (MSISDN) requested are from multiple countries that have disparate approaches to Directory and Number Services. This allows the requesting entity to be unaware of the specifics of each country's regulatory approach to Directory and Number Services. The approach shown above allows the requesting entity to be unaware of the specifics of each country's regulatory approach to Directory and Number Services.

Every country has its own regulatory approach for Directory and Number Services, comprising the rules in that country for how MSISDN should be searched and local law relating to the right of individuals to present or not present their number on directory services or to have their number fully or partially hidden on bills and other output. As for MNP, while the generalised scope of Directory and Number Services across countries is largely common the specific implementation varies for each country.

For example:
In the Netherlands a consumer may request that their MSISDN be masked where it appears on the bills or other records of other consumers. This masking takes the form of hashing out the last three digits of the MSISDN on such output.
In Germany certain MSISDN must not ever be shown on a bill or other output.
In Australia a consumer may opt in or out (default in) to their number being available to directory services organisations
In Poland the regulator must be informed of sold MSISDN immediately on activation

Such variation can be handled without complex central handling by using the same architectural approach as described above for MNP. The service logic will obviously be different, but will implement the same principles. The physical interaction with regulators and/or directory service operators is abstracted away from the logical processing to enable it to vary with each country. Common functions are grouped into domains that can vary in their implementation according to the needs of each specific realisation—these realisations can have an n-deep structure dependent on the specific complexity of the realisation. For example:
opt-in/opt-out logic for directory services may be largely common even though the actual integration to regulators is specific to the country;
number shielding approaches vary greatly across countries but fall into three or four generalised approaches (e.g. shield special numbers, shield your number on others output, shield numbers on consumers own output, etc.)

Another issue which can be managed scalably with this architectural model is classification of numbers. Numbers have associated data and metadata. The data tells us information about specific numbers. The metadata gives us information about the data itself and enables us to do many things; for example when a sale is made we can use the metadata to dynamically build a UI to ask the relevant questions about the kind of number we want to buy. Described below is a system for defining hierarchical metadata associated with classes of numbers.

A challenge for building a number managements system for a global mobile network operator is that not all data items associated with a number will be relevant in all cases, relevance can change over time, and new items may be needed with expansion into new countries. A conventional tabular classification of a number with metadata is shown in FIG. 23. This creates difficulty if new fields are needed.

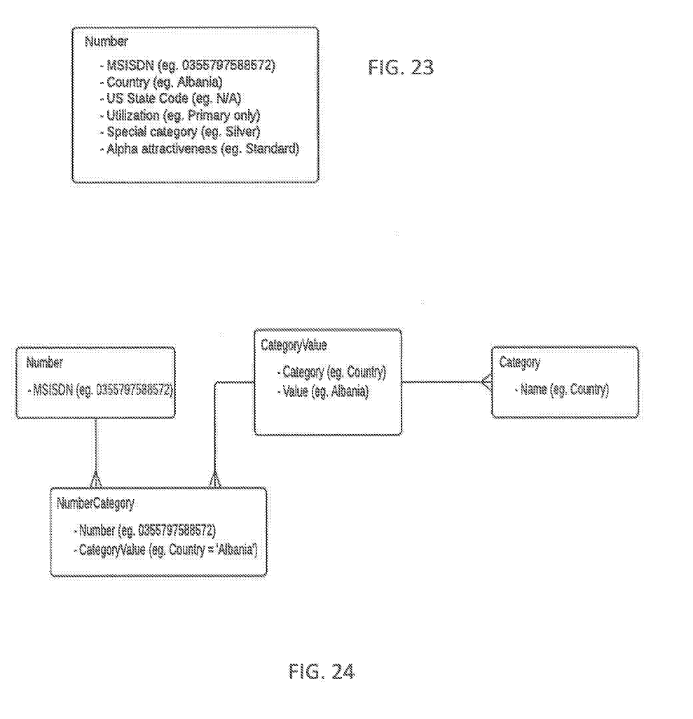

A better model is shown in FIG. 24, which uses a schema rather than a table. Now it is possible to add a new data item without changing the schema. To add a new item we;
add a new row to the Category table eg. ‘Country’
add all its possible values to the CategoryValue table eg. ‘Afghanistan’, ‘Albania’, ‘Algeria’. . .
add link entries to the NumberCategory table to associate one or more CategoryValues to a specific number eg. ‘Country=Algeria’ and ‘Utilization=Primary’

Further rules not present in this model may be represented as metadata. Examples are as follows:
If a number is a US number, State must also be supplied
If a number is US the utilization category must be defined
If a number is an Algerian number the Special category must be supplied
In future we may change utilization category so that it only applies to ‘Alabama’ and ‘Virginia’ numbers

This may be addressed by adding a dependency table. This defines a hierarchy of inter-dependent CategoryValue records to hold these rules. An example configuration is:

CategoryValue table

| Index | Category | Value |
|---|---|---|
| 0 | Country | Afghanistan |
| 1 | Country | Albania |
| 2 | Country | Algeria |
| . | . | . |
| . | . | . |
| . | . | . |
| 250 | Country | United States |
| 251 | Country | Venezuela |
| 252 | Country | Zimbabwe |
| 253 | State | Arkansas |
| 254 | State | Alabama |
| 255 | State | California |
| . | . | . |
| . | . | . |
| . | . | . |
| 308 | State | Virginia |
| 309 | State | Washington |
| 310 | Special | Silver |
| 311 | Special | Gold |
| 312 | Special | Standard |
| 313 | Utilization | Primary |
| 314 | Utilization | Primary or |
| | | Second |

Dependency table

| | | Dependent |
|---|---|---|
| | | on cat |
| Id | Category | value |
| 0 | Country | null |
| 1 | State | 250 |
| 2 | Special | 2 |
| 3 | Special | 255 |
| 4 | Utilization | 250 |

There may be a need to interpret the dependencies table in three scenarios;
When we load new numbers into the system, each number needs to be classified accordingly;
When we buy a number questions need to be asked about the kind of number we are interested in (this is the dynamic sales UI);
If the classification rules change and we need to re-analyse all numbers to see which we need to provide more information on.

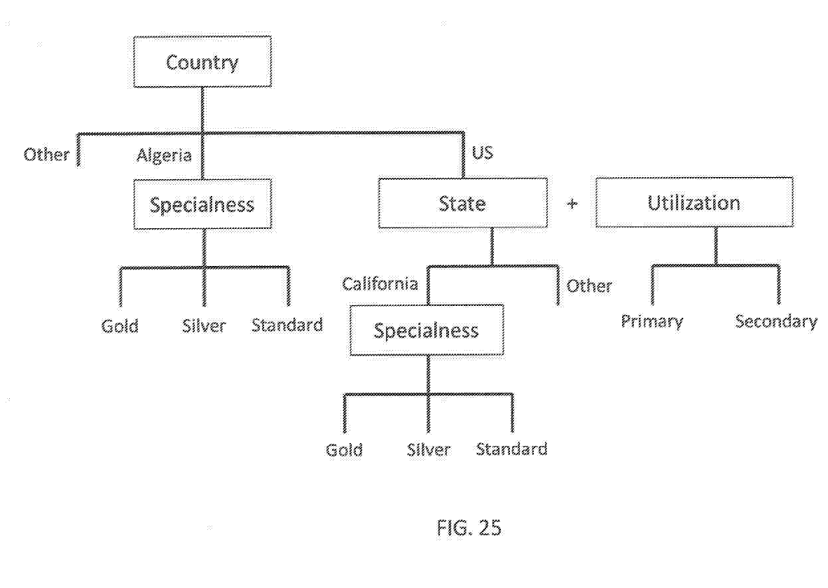

When a number or a range of numbers is categorised the dependency table is interpreted. Only the first row in this table doesn't contain a ‘dependent on’ value. This means the first row is applicable to all numbers. This record also references the countries category meaning all numbers must define the country they belong to. If we were dynamically building a UI to select a type of number to buy; this would result in a single list box displaying all the related CategoryValues (ie. All the countries of the world). One must be selected. Once a selection is made the dependency table is analysed again in light of the decision made. If US is selected from the list box, then rows 1 and 4 from the dependency table come into effect since they are ‘dependent on’ category value 250 (Country=‘US’). Row 1 says that a list box for the 52 US State Category values must be displayed. Row 4 similarly results in a list box being displayed from which we can select Utilization; ‘Primary’ or ‘Secondary’. If we select ‘California’ for the State, then an additional classification for the Special category; Gold, Silver or Standard is required. It can also be seen that the Special category also applies to ‘Algerian’ numbers (dependency table row 2). This is illustrated in FIG. 25.

This system is extremely flexible. It can be seen, for example, that it is trivial to replace a dependency table row to apply a utilization category to some US states only rather than all US states. The logic depicted would typically be encapsulated in a re-usable software component and embedded for various use cases. It would also be possible to dynamically update the dependencies table in response to changes in the number pool, for instance by removing the reference to the ‘New York’ category value when no New York numbers are available.

As indicated above, this architectural approach, and approach to providing services, is extremely powerful. It enables configuration of a mobile network for a multicountry network operator by implementing common elements in one or more central nodes while distributing time and volume critical elements to regional nodes. This supports configuring a telecommunications stack for the provision of mobile services to customers in multiple regions by abstracting the general elements into a central core of functionality and implementing framework adaptors to cope with regional variation. Where a regional variation needs to be implemented in a regional node, necessary functionality can be distributed to that node. Some regional nodes may also provide copies of central nodes, and can step in to provide redundancy.

This approach may be used to avoid previous geographical limitations while maintaining localisation for the subscriber. For example, origin IP packet translation may be provided so that a customer appears to be local to a geography, say Germany, when their packet traffic is being routed from Amsterdam. APN manipulation may take place initially based on a comparison of the subscriber's IMSI and the MNC/MCC combination provided by the SGSN.

Mapping may be made by the IP Backbone to a “national” IP address. For a subscriber to keep their own preferred country experience, then customer preferences could be used to override location information.

As described above, a localized APN may be provided to enable packet traffic to most efficiently route to the nearest GGSN or packet gateway. This supports optimisation of routing. For example, the network and user equipment may be dynamically configured for better routing of voice or data services and to set connection preferences for the user equipment to enable fast attachment. Similarly, the routing of voice and data for a given customer based on the source destination locations of the transaction destination and available routing resources across a partially distributed mobile telecommunications network such that signaling is centrally matched to enable billing and call control. Modifying the routing behaviour of a communication to a preferred delivery path may be based based on the technology (Wi-Fi/GSM/LTE) at the origin, destination bearer and location. Efficient routing may also be chosen to enable forwarding of SMS and Voice calls in a distributed network without requiring tromboning of media and SMS via third party networks.

Multiple mobile numbers from multiple countries or from one country may be provided which map to services intelligently such that all services are available for all numbers modified by the source location and destination number and or location.

Common services may be provided across different international identifiers. For example, a single bill, customer service and voicemail may be provided for a subscriber despite the subscriber having multiple international identifiers. Similarly lawful intercept and emergency services may be provided across multiple international identifiers. A particular benefit of using this approach with a system for provisioning a subscriber with multiple identifiers as in WO 2011/036484 is that it is easier to reconcile these subscriber identities for common service provision. User experience can be chosen to allow the customer to dial home country destinations in national format even when roaming, for example, and caller line identification and restriction may be provided consistently for a subscriber across multiple geographies, to the extent permitted by law.

This model has further consequences for network management. For example, active network probes may be distributed throughout the network so as to operate as one logical node, allowing the probe system as a whole to be quality assured. The network probes may each have their own identifier, and may communicate accordingly, but at a high level they will interact with other elements and services as a single logical node.

As described above, a service model using a hierarchical service description with a centrally implemented general model and regionally implemented regional variation may be employed. For mobile number portability, this may involve porting numbers concurrently in multiple countries despite the presence of different porting models in those countries. This allows for integration to multiple international models of MNP using a standardized framework such that only the smallest number of elements must be adapted at each layer of the protocol. For directory and number services, this may involve providing a multi country number and short-code mapping service such that commonly known numbers such as Directory services (UK 118, US 555 etc.) and paid services are resolved to each countries local numbering scheme or home number system according to rules based on home, location and previous history. Numbering laws may be mapped multi-nationally so that numbers are shown correctly in each local jurisdiction according to local practice.

This approach also supports number management by reserving preferred numbers across multiple geographies. This may involve, for example, reserving similar numbers in multiple countries once a customer has purchased a number in one country.

Other country-independent packaging of services is possible using this model. For example, it is possible to enable a group of individuals can share a common pool of minutes across geographical boundaries while being optionally legally contracted to and billed in differing currencies.

1. A method of managing a mobile network to provide cellular telecommunications services to a subscriber in a plurality of countries, the method comprising:
providing a first set of said cellular telecommunications services from a central node covering all of the plurality of countries; and
providing a second set of said cellular telecommunications services from a plurality of regional nodes, each regional node providing the second set of cellular communications services to a subset of the plurality of countries.

2. A method as claimed in claim 1 , wherein the second set of services comprise time or volume critical services.

3. A method as claimed in claim 2, wherein the time or volume critical services comprise voice and data services.

4. A method as claimed in claim 1, wherein the first set of services comprise business support services and operational support services.

5. A method as claimed in claim 1, wherein the regional nodes comprise multicountry nodes and local nodes supporting a single country.

6. A method as claimed in claim 1, wherein there is a plurality of nodes adapted to act as the central node.

7. A method as claimed in claim 6, wherein one or more of the regional nodes is adapted to act as a central node in the event of failure of the central node.

8. A method as claimed in claim 1, wherein a dedicated communications backbone is provided between the central node and the regional nodes.

9. A method as claimed in claim 1, wherein there is a plurality of nodes adapted to act as a, or the, regional node for one of the plurality of countries.

10. A method as claimed in claim 9, wherein a regional node is adapted to provide load balancing between countries of a plurality of countries supported by that regional node.

11. A method as claimed in claim 9, wherein a regional node supporting a first plurality of countries is adapted to support a second plurality of countries supported by a further regional node in the event of failure of the further regional node.

12. A method as claimed in claim 1, wherein the central node provides at least one operational support service as a region-independent core service, and a regional adaptation service is also provided.

13. A method as claimed in claim 12, wherein the regional adaptation service is provided at a regional node.

14. A method as claimed in claim 1, comprising providing an indication of a subscriber's local country independent of the node providing services to the subscriber.

15. A method as claimed in claim 14, comprising providing origin IP packet translation.

16. A method as claimed in claim 1, comprising providing a choice of access points at regional nodes to allow for efficient routing of mobile packets to a gateway.

17. A method as claimed in claim 1, comprising optimising routing of voice or data services with signalling to the central node for provision of business support services and operational support services.

18. A method as claimed in claim 1, where services are mapped from common numbers or a group of common numbers according to source location, destination number or location.

19. A method as claimed in claim 18, wherein said numbers comprise directory services.

20. A method as claimed in claim 1, wherein a subscriber has multiple international identifiers.

21. A method as claimed in claim 20, wherein customer support services are provided consistently to the subscriber across the multiple international identifiers.

22. A method as claimed in claim 20, wherein lawful intercept is provided consistently for the subscriber across the multiple international identifiers.

23. A method as claimed in claim 20, wherein emergency services are provided consistently for the subscriber across the multiple international identifiers.

24. A method as claimed in claim 1, providing mobile number portability between countries.

25. A method as claimed in claim 24, wherein different porting models for different countries are provided by one or more regional adaptation services.

26. A method as claimed in claim 1, comprising reserving related numbers across multiple countries when a subscriber has obtained a number in one country.

27. A method as claimed in claim 1, comprising mapping numbers for display according to local mapping rules for each country.

28. A method as claimed in claim 1, comprising grouping for business support services specific network services for multiple subscribers.

29. A method as claimed in claim 28, wherein the multiple subscribers are local to different countries.
